(19) United States
(12) Patent Application Publication
(10) Pub. No.: US 2026/0018639 A1
(43) Pub. Date: Jan. 15, 2026

(54) ARTIFICIAL PHOTOSYNTHESIS ENERGY SYSTEMS AND METHODS

(71) Applicant: SHAHEEN INNOVATIONS HOLDING LIMITED, Abu Dhabi (AE)

(72) Inventors: Shaikh Zayed Hamid Zayed Sultan Alnehayan, Abu Dhabi (AE); Mohammed Alshaiba Saleh Ghannam Almazrouei, Abu Dhabi (AE)

(21) Appl. No.: 19/267,212

(22) Filed: Jul. 11, 2025

Related U.S. Application Data
(60) Provisional application No. 63/671,229, filed on Jul. 14, 2024.

(51) Int. Cl. H01M 8/0656; C25B 1/04; C25B 1/27; C25B 1/55; C25B 3/03; C25B 3/07; C25B 9/50; C25B 15/027; C25B 15/029; C25B 15/08; H01M 8/0432; H01M 8/0438; H01M 8/0444; H01M 8/04537; H01M 8/04746; H01M 8/1011; H01M 8/22

(52) U.S. Cl. CPC H01M 8/0656; C25B 1/04; C25B 1/27; C25B 1/55; C25B 3/03; C25B 3/07; C25B 9/50; C25B 15/027; C25B 15/029; C25B 15/087; H01M 8/0432; H01M 8/04373; H01M 8/0438; H01M 8/04402; H01M 8/04425; H01M 8/04462; H01M 8/04611; H01M 8/04753; H01M 8/04761; H01M 8/04776; H01M 8/1011; H01M 8/222

(57) ABSTRACT

There is provided an artificial photosynthesis energy device, the device comprising: an artificial photosynthesis fuel generator, incorporating: an inlet for receiving at least one of a feed material and at least one byproduct, a reactor which uses light energy from a light source to convert the at least one of the feed material and the at least one byproduct to a fuel, and an outlet which feeds the fuel to a power generator which generates electricity and produces the at least one byproduct from the fuel; the power generator, incorporating: an inlet fluidly connected to the outlet of the artificial photosynthesis fuel generator, and an outlet, wherein the device further comprises: a recycler which directs at least a portion of the at least one byproduct from the outlet of the power generator to the inlet of the artificial photosynthesis fuel generator.

### CROSS-REFERENCE TO RELATED APPLICATION

This application claims the benefit of priority to provisional patent application Ser. No. 63/671,229, filed Jul. 14, 2024, all of which is incorporated by reference herein.

### BACKGROUND

Growing global energy demand and concerns over climate change have spurred development of sustainable power technologies.

Solar and wind energy have become viable electricity sources, but their intermittency and storage challenges drive the need for storable fuels made from renewable resources.

Artificial photosynthesis has emerged as a promising approach to convert abundant inputs (sunlight, water, and carbon dioxide) into chemical fuels.

In artificial photosynthesis, human-engineered devices mimic plant processes by using sunlight to produce energy-rich molecules (fuels) from water and CO₂. For example, solar-driven chemical reactions can split water to generate hydrogen fuel, or reduce carbon dioxide (with water) to produce hydrocarbon fuels like methanol. These solar fuels can be stored and transported, allowing solar energy to be saved for use when sunlight is not available.

Conventional renewable energy systems often generate electricity directly (e.g. photovoltaic panels) or produce fuels in stand-alone units.

While batteries can store electrical energy, many heavy-duty applications require the higher energy density of chemical fuels.

A significant portion of transportation (e.g. trucks, ships, aircraft) cannot be practically electrified with batteries alone, necessitating high-energy-density, carbon-neutral liquid fuels for those sectors.

There is a need to develop a system providing sustainable electricity with minimal emissions that can operate continuously.

It is an aim of the present disclosure to address to provide an artificial photosynthesis energy device designed for efficiency, continuous operation, and environmental sustainability.

### BRIEF DESCRIPTION OF THE INVENTION

The present disclosure relates to artificial photosynthesis energy systems and methods. More particularly, although not exclusively, the present disclosure relates to artificial photosynthesis energy systems, devices, and methods, and more particularly, although not exclusively, to a closed-loop power generation system wherein fuel is produced in situ via artificial photosynthesis and then used to generate power in a manner that recycles the reactants.

### Representative Features

Representative features are set out in the following clauses, which stand alone or may be combined, in any combination, with one or more features disclosed in the text and/or drawings of the specification.
1. An artificial photosynthesis energy device, the device comprising: an artificial photosynthesis fuel generator, incorporating: an inlet for receiving at least one of a feed material and at least one byproduct, a reactor which incorporates a solar concentrator which concentrates light energy from a light source and uses the concentrated light energy to convert the at least one of the feed material and the at least one byproduct to a fuel, and an outlet which feeds the fuel to a power generator which generates electricity and produces the at least one byproduct from the fuel; the power generator, incorporating: an inlet fluidly connected to the outlet of the artificial photosynthesis fuel generator, and an outlet, wherein the device further comprises: a recycler which directs at least a portion of the at least one byproduct from the outlet of the power generator to the inlet of the artificial photosynthesis fuel generator, wherein the reactor of the artificial photosynthesis fuel generator is one of: a photoelectrochemical reactor incorporating a photoactive electrode; and a catalyst for improving the efficiency of conversion of the feed material into the fuel; wherein at least one of the feed material and the at least one byproduct comprises water, the artificial photosynthesis fuel generator is configured to produce hydrogen gas from at least one of the feed material and the at least one byproduct, and the power generator comprises a hydrogen fuel cell; wherein the device further comprises: a controller incorporating at least one sensor which measures at least one parameter selected from a group of parameters including: rate of fuel production of the artificial photosynthesis fuel generator; pressure in the power generator; temperature in the power generator; pressure in the artificial photosynthesis fuel generator; temperature in the artificial photosynthesis fuel generator; power output level of the power generator; composition of the at least one byproduct produced by the power generator; flowrate of feed material into the artificial photosynthesis fuel generator; and flowrate of the at least one byproduct produced by the power generator, wherein the device comprises at least one of: a valve located in a flowpath between the artificial photosynthesis fuel generator and the power generator, the controller controlling the valve to modulate a flowrate of the fuel produced from the artificial photosynthesis fuel generator to the power generator; a valve located in a flowpath between the power generator and the recycler, the controller controlling the valve to modulate a flowrate of the byproduct produced from the artificial photosynthesis fuel generator to the recycler; and a valve located in a flowpath between the recycler and the artificial photosynthesis fuel generator, the controller controlling the valve to modulate a flowrate of the byproduct to the artificial photosynthesis fuel generator, and wherein the controller monitors each parameter and controls the artificial photosynthesis fuel generator, the power generator, and each valve to balance the rate of fuel production from the artificial photosynthesis fuel generator and the power output level of the power generator.
2. An artificial photosynthesis energy device, the device comprising: an artificial photosynthesis fuel generator, incorporating: an inlet for receiving at least one of a feed material and at least one byproduct, a reactor which uses light energy from a light source to convert the at least one of the feed material and the at least one byproduct to a fuel, and an outlet which feeds the fuel to a power generator which generates electricity and produces the at least one byproduct from the fuel; the power generator, incorporating: an inlet fluidly connected to the outlet of the artificial photosynthesis fuel generator, and an outlet, wherein the device further comprises: a recycler which directs at least a portion of the at least one byproduct from the outlet of the power generator to the inlet of the artificial photosynthesis fuel generator.
3. The device according to clause 2, wherein the artificial photosynthesis fuel generator comprises a gas outlet for feeding gas produced by the conversion of feed material and light energy to the fuel to the power generator.
4. The device according to clause 2 or 3, wherein the reactor of the artificial photosynthesis fuel generator is a photoelectrochemical reactor, comprising: a photoactive electrode and a catalyst for improving the efficiency of conversion of the feed material into the fuel.
5. The device according to clause 2 or 3, wherein the reactor of the artificial photosynthesis fuel generator is a bio-hybrid reactor, comprising at least one of an algae and a bacteria.
6. The device according to any of clauses 2 to 5, wherein the artificial photosynthesis fuel generator comprises a solar concentrator which concentrates the light energy from the light source.
7. The device according to any of clauses 2 to 6, wherein at least one of the feed material and the at least one byproduct comprises water.
8. The device according to clause 7, wherein the artificial photosynthesis fuel generator is configured to produce hydrogen gas from at least one of the feed material and the at least one byproduct.
9. The device according to clause 8, wherein the power generator comprises a hydrogen fuel cell.
10. The device according to clause 7, wherein at least one of the feed material and the at least one byproduct further comprises a nitrogen containing gas or nitrogen gas.
11. The device according to clause 10, wherein the artificial photosynthesis fuel generator is configured to produce ammonia from at least one of the feed material and the at least one byproduct.
12. The device according to any of clauses 2 to 6, wherein at least one of the feed material and the at least one byproduct comprises carbon dioxide and hydrogen.
13. The device according to clause 12, wherein the artificial photosynthesis fuel generator is configured to produce at least one of an alcohol and a hydrocarbon from at least one of the feed material and the at least one byproduct.
14. The device according to clause 13, wherein the artificial photosynthesis fuel generator comprises at least one of: a gas turbine coupled to an electrical generator; an internal combustion engine coupled to an electrical generator; and a direct methanol fuel cell.
15. The device according to clause 14, further comprising a gas capturer fluidly connected to the power generator and to the recycler, the gas capturer configured to capture at least a portion of at least one of carbon dioxide and water from the power generator and feed the at least one of carbon dioxide and water to the artificial photosynthesis fuel generator.
16. The device according to any of clauses 2 to 15, wherein the artificial photosynthesis fuel generator comprises at least one of a cooling system and a heating system.
17. The device according to any of clauses 2 to 16, further comprising at least one of a fuel reservoir and a storage tank fluidly connected between the artificial photosynthesis fuel generator and power generator, the at least one of the fuel reservoir and storage tank arranged to selectively receive at least a portion of the fuel produced by the artificial photosynthesis fuel generator.
18. The device according to any of clauses 2 to 17, further comprising an auxiliary energy storage system for collecting and storing solar energy.
19. The device according to any of clauses 2 to 18, further including an auxiliary light source for providing solar energy to the artificial photosynthesis fuel generator.
20. The device according to any of clauses 2 to 19, further including a controller, the controller comprising at least one sensor, the at least one sensor configured to perform measurements of at least one parameter selected from a group of parameters including: rate of fuel production of the artificial photosynthesis fuel generator; pressure in the power generator; temperature in the power generator; pressure in the artificial photosynthesis fuel generator; temperature in the artificial photosynthesis fuel generator; power output level of the power generator; composition of the at least one byproduct produced by the power generator; flowrate of feed material into the artificial photosynthesis fuel generator; and flowrate of the at least one byproduct produced by the power generator.
21. The device according to clause 20, further comprising at least one of: a valve located in a flowpath between the artificial photosynthesis fuel generator and the power generator, the controller being configured to control the valve to modulate a flowrate of the fuel produced from the artificial photosynthesis fuel generator to the power generator; a valve located in a flowpath between the power generator and the recycler, the controller being configured to control the valve to modulate a flowrate of the byproduct produced from the power generator to the recycler; and a valve located in a flowpath between the recycler and the artificial photosynthesis fuel generator, the controller being configured to control the valve to modulate a flowrate of the byproduct to the artificial photosynthesis fuel generator.
22. The device of clause 21, wherein the controller is configured to monitor each parameter and control the artificial photosynthesis fuel generator, the power generator, and each valve to balance the rate of fuel production from the artificial photosynthesis fuel generator and the power output level of the power generator.
23. The device of any of clauses 20 to 22, wherein the device includes a cooling water pump which controls cooling water flow to at least one of the artificial photosynthesis fuel generator and the power generator and wherein the controller is configured to control the cooling water pump to control the temperature of at least one of the artificial photosynthesis fuel generator and the power generator.
24. An artificial photosynthesis energy system, comprising: an artificial photosynthesis fuel generator, incorporating: an inlet for receiving at least one of a feed material and at least one byproduct, a reactor which uses light energy from a light source to convert the feed material to a fuel, and an outlet which feeds the fuel to a power generator which generates electricity and produces the at least one byproduct from the fuel; the power generator, incorporating: an inlet fluidly connected to the outlet of the artificial photosynthesis fuel generator, and an outlet; and a recycler which directs at least a portion of the at least one byproduct from the outlet of the power generator to the inlet of the artificial photosynthesis fuel generator.
25. A method of generating power using artificial photosynthesis, comprising: flowing at least one of: a feed material, and at least one byproduct, through an inlet of an artificial photosynthesis fuel generator, wherein the artificial photosynthesis fuel generator comprises a catalyst; converting the at least one of: the feed material, and the at least one byproduct, to a fuel using light energy, wherein at least one of the feed material and the at least one byproduct comprises hydrogen; flowing the fuel through an outlet of the artificial photosynthesis fuel generator and through an inlet of a power generator; generating electricity using a fuel cell and generating a byproduct from the reaction of the fuel at the fuel cell; and flowing at least a portion of the byproduct through a recycler through the inlet of the artificial photosynthesis fuel generator.
26. An artificial photosynthesis energy device, the device comprising: an artificial photosynthesis fuel generator, incorporating: an inlet for receiving at least one of a feed material and at least one byproduct, a reactor which incorporates a solar concentrator which concentrates light energy from a light source and uses the concentrated light energy to convert the at least one of the feed material and the at least one byproduct to a fuel, and an outlet which feeds the fuel to a power generator which generates electricity and produces the at least one byproduct from the fuel; the power generator, incorporating: an inlet fluidly connected to the outlet of the artificial photosynthesis fuel generator, and an outlet, wherein the device further comprises: a recycler which directs at least a portion of the at least one byproduct from the outlet of the power generator to the inlet of the artificial photosynthesis fuel generator, wherein the reactor of the artificial photosynthesis fuel generator is one of: a photoelectrochemical reactor incorporating a photoactive electrode; and a catalyst for improving the efficiency of conversion of the feed material into the fuel, or a bio-hybrid reactor, incorporating at least one of algae and bacteria; wherein one of: at least one of the feed material and the at least one byproduct comprises water, the artificial photosynthesis fuel generator is configured to produce hydrogen gas from at least one of the feed material and the at least one byproduct, and the power generator comprises a hydrogen fuel cell; at least one of the feed material and the at least one byproduct comprises water and further comprises a nitrogen containing gas or nitrogen gas, the artificial photosynthesis fuel generator is configured to produce an ammonia from the feed material and/or the at least one byproduct; at least one of the at least one of the feed material and the at least one byproduct comprises carbon dioxide and hydrogen, the artificial photosynthesis fuel generator is configured to produce at least one of an alcohol and a hydrocarbon from the at least one of the feed material and the at least one byproduct, and the artificial photosynthesis fuel generator comprises at least one of: a gas turbine coupled to an electrical generator; an internal combustion engine coupled to an electrical generator; and a direct methanol fuel cell; wherein the device further comprises: a controller incorporating at least one sensor which measures at least one parameter selected from a group of parameters including: rate of fuel production of the artificial photosynthesis fuel generator; pressure in the power generator; temperature in the power generator; pressure in the artificial photosynthesis fuel generator; temperature in the artificial photosynthesis fuel generator; power output level of the power generator; composition of the at least one byproduct produced by the power generator; flowrate of feed material into the artificial photosynthesis fuel generator; and flowrate of the at least one byproduct produced by the power generator, wherein the device comprises at least one of: a valve located in a flowpath between the artificial photosynthesis fuel generator and the power generator, the controller controlling the valve to modulate a flowrate of the fuel produced from the artificial photosynthesis fuel generator to the power generator; a valve located in a flowpath between the power generator and the recycler, the controller controlling the valve to modulate a flowrate of the byproduct produced from the artificial photosynthesis fuel generator to the recycler; and a valve located in a flowpath between the recycler and the artificial photosynthesis fuel generator, the controller controlling the valve to modulate a flowrate of the byproduct to the artificial photosynthesis fuel generator, and wherein the controller monitors each parameter and controls the artificial photosynthesis fuel generator, the power generator, and each valve to balance the rate of fuel production from the artificial photosynthesis fuel generator and the power output level of the power generator.
27. An artificial photosynthesis energy device, the device comprising: an artificial photosynthesis fuel generator, incorporating: an inlet for receiving at least one of a feed material and at least one byproduct, a reactor which incorporates a solar concentrator which concentrates light energy from a light source and uses the concentrated light energy to convert the at least one of the feed material and the at least one byproduct to a fuel, and an outlet which feeds the fuel to a power generator which generates electricity and produces the at least one byproduct from the fuel; the power generator, incorporating: an inlet fluidly connected to the outlet of the artificial photosynthesis fuel generator, and an outlet, wherein the device further comprises: a recycler which directs at least a portion of the at least one byproduct from the outlet of the power generator to the inlet of the artificial photosynthesis fuel generator, wherein the reactor of the artificial photosynthesis fuel generator is one of: a photoelectrochemical reactor incorporating a photoactive electrode; and a catalyst for improving the efficiency of conversion of the feed material into the fuel; wherein at least one of the at least one of the feed material and the at least one byproduct comprises carbon dioxide and hydrogen, the artificial photosynthesis fuel generator is configured to produce at least one of an alcohol and a hydrocarbon from the at least one of the feed material and the at least one byproduct, and the artificial photosynthesis fuel generator comprises at least one of: a gas turbine coupled to an electrical generator; an internal combustion engine coupled to an electrical generator; and a direct methanol fuel cell; wherein the device further comprises: a controller incorporating at least one sensor which measures at least one parameter selected from a group of parameters including: rate of fuel production of the artificial photosynthesis fuel generator; pressure in the power generator; temperature in the power generator; pressure in the artificial photosynthesis fuel generator; temperature in the artificial photosynthesis fuel generator; power output level of the power generator; composition of the at least one byproduct produced by the power generator; flowrate of feed material into the artificial photosynthesis fuel generator; and flowrate of the at least one byproduct produced by the power generator, wherein the device comprises at least one of: a valve located in a flowpath between the artificial photosynthesis fuel generator and the power generator, the controller controlling the valve to modulate a flowrate of the fuel produced from the artificial photosynthesis fuel generator to the power generator; a valve located in a flowpath between the power generator and the recycler, the controller controlling the valve to modulate a flowrate of the byproduct produced from the artificial photosynthesis fuel generator to the recycler; and a valve located in a flowpath between the recycler and the artificial photosynthesis fuel generator, the controller controlling the valve to modulate a flowrate of the byproduct to the artificial photosynthesis fuel generator, and wherein the controller monitors each parameter and controls the artificial photosynthesis fuel generator, the power generator, and each valve to balance the rate of fuel production from the artificial photosynthesis fuel generator and the power output level of the power generator.
28. An artificial photosynthesis energy device, the device comprising: an artificial photosynthesis fuel generator, incorporating: an inlet for receiving at least one of a feed material and at least one byproduct, a reactor which incorporates a solar concentrator which concentrates light energy from a light source and uses the concentrated light energy to convert the at least one of the feed material and the at least one byproduct to a fuel, and an outlet which feeds the fuel to a power generator which generates electricity and produces the at least one byproduct from the fuel; the power generator, incorporating: an inlet fluidly connected to the outlet of the artificial photosynthesis fuel generator, and an outlet, wherein the device further comprises: a recycler which directs at least a portion of the at least one byproduct from the outlet of the power generator to the inlet of the artificial photosynthesis fuel generator, wherein the reactor of the artificial photosynthesis fuel generator is one of: a photoelectrochemical reactor incorporating a photoactive electrode; and a catalyst for improving the efficiency of conversion of the feed material into the fuel; wherein at least one of the feed material and the at least one byproduct comprises water and further comprises a nitrogen containing gas or nitrogen gas, the artificial photosynthesis fuel generator is configured to produce an ammonia from the feed material and/or the at least one byproduct; wherein the device further comprises: a controller incorporating at least one sensor which measures at least one parameter selected from a group of parameters including: rate of fuel production of the artificial photosynthesis fuel generator; pressure in the power generator; temperature in the power generator; pressure in the artificial photosynthesis fuel generator; temperature in the artificial photosynthesis fuel generator; power output level of the power generator; composition of the at least one byproduct produced by the power generator; flowrate of feed material into the artificial photosynthesis fuel generator; and flowrate of the at least one byproduct produced by the power generator, wherein the device comprises at least one of: a valve located in a flowpath between the artificial photosynthesis fuel generator and the power generator, the controller controlling the valve to modulate a flowrate of the fuel produced from the artificial photosynthesis fuel generator to the power generator; a valve located in a flowpath between the power generator and the recycler, the controller controlling the valve to modulate a flowrate of the byproduct produced from the artificial photosynthesis fuel generator to the recycler; and a valve located in a flowpath between the recycler and the artificial photosynthesis fuel generator, the controller controlling the valve to modulate a flowrate of the byproduct to the artificial photosynthesis fuel generator, and wherein the controller monitors each parameter and controls the artificial photosynthesis fuel generator, the power generator, and each valve to balance the rate of fuel production from the artificial photosynthesis fuel generator and the power output level of the power generator.
29. A method of generating power using artificial photosynthesis, comprising: flowing at least one of: a feed material, and at least one byproduct, through an inlet of an artificial photosynthesis fuel generator, wherein the artificial photosynthesis fuel generator comprises at least one of a catalyst, a photocatalyst, a biohybrid reactor including at least one of algae and bacteria, and a solar concentrator which concentrates light energy from a light source; converting the at least one of: the feed material, and the at least one byproduct, to a fuel using light energy, wherein at least one of the feed material and the at least one byproduct comprises at least one of: hydrogen, carbon dioxide, and water; flowing the fuel through an outlet of the artificial photosynthesis fuel generator and through an inlet of a power generator; generating electricity using at least one of a fuel cell and a combustion engine and generating a byproduct from at least one of the reaction of the fuel at the fuel cell and combustion in the combustion engine; and flowing at least a portion of the byproduct through a recycler through the inlet of the artificial photosynthesis fuel generator.
30. A method of generating power using artificial photosynthesis, comprising: flowing at least one of: a feed material, and at least one byproduct, through an inlet of an artificial photosynthesis fuel generator, wherein the artificial photosynthesis fuel generator comprises at least one of a catalyst, a photocatalyst, a biohybrid reactor including algae and/or bacteria and a solar concentrator which concentrates light energy from a light source; converting the at least one of: the feed material, and the at least one byproduct, to a fuel using light energy, wherein at least one of the feed material and the at least one byproduct comprises at least one of: hydrogen, carbon dioxide, nitrogen, and water; flowing the fuel through an outlet of the artificial photosynthesis fuel generator and through an inlet of a power generator; generating electricity using at least one of a fuel cell and a combustion engine and generating a byproduct from at least one of the reaction of the fuel at the fuel cell and combustion in the combustion engine; and flowing at least a portion of the byproduct through a recycler through the inlet of the artificial photosynthesis fuel generator.
31. A method of generating power using artificial photosynthesis, comprising: flowing at least one of: a feed material, and at least one byproduct, through an inlet of an artificial photosynthesis fuel generator, wherein the artificial photosynthesis fuel generator comprises a catalyst; converting the at least one of: the feed material, and the at least one byproduct, to a fuel using light energy, wherein at least one of the feed material and the at least one byproduct comprises carbon dioxide and water; flowing the fuel through an outlet of the artificial photosynthesis fuel generator and through an inlet of a power generator; generating electricity using at least one of a fuel cell and a combustion engine and generating a byproduct from at least one of the reaction of the fuel at the fuel cell and combustion in the combustion engine; and flowing at least a portion of the byproduct through a recycler through the inlet of the artificial photosynthesis fuel generator.
32. A method of generating power using artificial photosynthesis, comprising: flowing at least one of: a feed material, and at least one byproduct, through an inlet of an artificial photosynthesis fuel generator, wherein the artificial photosynthesis fuel generator comprises a biohybrid reactor including at least one of algae and bacteria, and a solar concentrator which concentrates light energy from a light source; converting the at least one of: the feed material, and the at least one byproduct, to a fuel using light energy, wherein the feed material and the at least one byproduct comprises at least one of: hydrogen, carbon dioxide, and water; flowing the fuel through an outlet of the artificial photosynthesis fuel generator and through an inlet of a power generator; generating electricity using at least one of a fuel cell and a combustion engine and generating a byproduct from at least one of the reaction of the fuel at the fuel cell and combustion in the combustion engine; and flowing at least a portion of the byproduct through a recycler through the inlet of the artificial photosynthesis fuel generator.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a schematic view of an artificial photosynthesis energy device, embodying the present disclosure.

### DETAILED DESCRIPTION OF THE DISCLOSURE

Artificial photosynthesis—the chemical process that mimics the natural process of photosynthesis, is a scheme for capturing and storing energy from sunlight by producing a fuel (solar fuel). An advantage of artificial photosynthesis is that solar energy can be converted and stored with a carbon-neutral artificially photosynthesized fuel. Although solar fuel production has been demonstrated in laboratory experiments, generally the economics of artificial photosynthesis remain noncompetitive.

Disclosed in an embodiment is a closed-loop sustainable energy integrative device that generates electric power from solar fuel produced by artificial photosynthesis (e.g., artificial leaf). In such a device design, the only inputs may be carbon dioxide and water.

Under sunlight and with the addition of specialized photocatalysts or enzymes, carbon dioxide and water can be converted into a solar fuel, which is then used to generate electric power.

Assuming the solar fuel is a methanol (CH₃OH), the closed-loop sustainable energy device can include the following two steps:
(1) Solar-driven photocatalytic conversion of CO₂ and H₂O feedstock into methanol (solar fuel). For example, a possible route for photocatalytic conversion of CO₂ to methanol includes the use of low-dimensional high performance photocatalysts, such as polymeric-C3N4/CdSe quantum dots, in the form of polymeric C3N4 nanosheets and CdSe quantum dots etc.
(2) Methanol is used as the fuel to generate power in a direct methanol fuel cell, which is a type of proton-exchange fuel cell. The fuel cell relies on the oxidation of methanol on a catalyst (e.g., Pt) layer to form carbon dioxide, while water is consumed at the anode and produced at the cathode. Protons (H+) are transported across the proton exchange membrane (often made from Nafion) to the cathode where they react with oxygen to produce water. Electrons are transported through an external circuit from anode to cathode, thus generating power.

If the solar fuel is alcohol or sugar instead of methanol, then the integrative closed-loop sustainable energy device would have three steps, with an additional intermediate step of multi-catalyst/multi-enzyme cascade pathway to convert methanol to alcohol or sugar. For example, methanol can be first converted to formaldehyde through thermochemical reaction, then formaldehyde can be converted to D-glucose and other sugar via a formose reaction. Rather than direct methanol fuel cell, enzymatic biofuel cell, a specific type that uses enzymes (not precious metals such as Pt and Au) as the catalysts to oxidize the fuel (e.g., sugar), would be required to generate power.

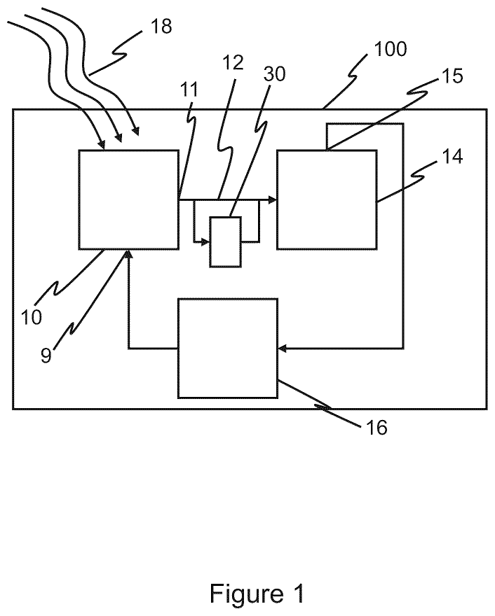

As shown in FIG. 1, there is provided an artificial photosynthesis energy device 100. The device 100 comprises: an artificial photosynthesis fuel generator 10, incorporating: an inlet 9 for receiving at least one of a feed material and at least one byproduct, a reactor which uses light energy from a light source (e.g., sunlight 18) to convert the feed material and light energy to a fuel, and an outlet 11 which feeds the fuel to a power generator 14 which generates electricity and produces the at least one byproduct from the fuel. The power generator 14 incorporates: an inlet 13 fluidly connected to the outlet 11 of the artificial photosynthesis fuel generator 10, and an outlet; and a recycler 16 which directs at least a portion of the at least one byproduct from the outlet of the power generator 14 to the inlet 9 of the artificial photosynthesis fuel generator 10.

The device 100 may, therefore, form a closed processing loop, as described in more detail herein. In particular, the artificial photosynthesis fuel generator 10, the power generator 14, and the recycler 16 may form a closed processing loop where major inputs and outputs for each stage (e.g., artificial photosynthesis, power generation) of the device 100 are contained within the device 100 and recycled. The artificial photosynthesis energy device 100 may be considered as a combined fuel-production and power generation device. It will be appreciated that the feed material may be (e.g., initially) provided to the inlet 9 of the artificial photosynthesis fuel generator 10 from source external to the device 100, for example, prior to and/or during a first start-up of the device. It will also be appreciated that the device 100, during use, may operate on the byproduct produced by the power generator 14 (e.g., such that no external feed is provided to the device 100), which may maintain a closed loop as described herein. The device 100 may comprise a feed storage tank for providing feed to the artificial photosynthesis fuel generator 10 prior to and/or during initial start-up. The feed storage tank may store feed material and/or the at least one byproduct for use by the artificial photosynthesis fuel generator 10. The feed storage tank may act as a flow buffer to the artificial photosynthesis fuel generator 10 (e.g., regulating flow to the artificial photosynthesis fuel generator 10).

The artificial photosynthesis energy device 100 may be considered to be a sustainable power generation system. The sustainable power generation system may include: i) an artificial photosynthesis fuel generator 10 configured to produce a fuel using input reactants including at least water and carbon dioxide, the artificial photosynthesis fuel generator 10 being driven by light energy to chemically synthesize the fuel. The system may include ii) a power generator 14 configured to receive the fuel from the artificial photosynthesis fuel generator 10 and to generate power by reacting the fuel (with an oxidant) to produce usable energy, thereby yielding exhaust byproducts containing water and carbon dioxide. The system may include iii) a recycling subsystem coupled between an output of the power generator 14 and an input of the artificial photosynthesis fuel generator 10, the recycling subsystem being configured to capture the exhaust byproducts from the power generator 14 and supply at least a portion of the carbon dioxide and water back to the artificial photosynthesis fuel generator 10 as the input reactants. As described herein in relation to the device 100, the system may operate in a closed-loop manner such that the carbon dioxide and water consumed in producing the fuel are replenished by the carbon dioxide and water recovered from the power generator 14, thereby achieving substantially carbon-neutral power generation.

The artificial photosynthesis fuel generator 10 may comprise a gas outlet for feeding gas produced by the conversion of the at least one of the feed material and the at least one byproduct and light energy to the fuel to the power generator 14. The gas produced by the conversion of the feed material and/or the at least one byproduct may include oxygen, particularly if water is used, as described in more detail herein. Accordingly, the production of fuel by the artificial photosynthesis fuel generator 10 may also produce an oxidant for use in the power generator 14 (e.g., for combustion).

Accordingly, the power generator 14 may receive a feed of the fuel from the artificial photosynthesis fuel generator 10 and a feed of gas for aiding, for example, in combustion in the power generator 14.

The device 100 may further comprise at least one of a fuel reservoir and a storage tank 30 fluidly connected between the artificial photosynthesis fuel generator 10 and the power generator 14. It will be appreciated that more than one fuel reservoir and/or storage tank 30 may be provided. The at least one of the fuel reservoir and storage tank 30 may be arranged to selectively receive at least a portion of the fuel produced by the artificial photosynthesis fuel generator 10. A controller (as described in more detail herein) may control flow of at least a portion of the fuel to the power generator 14 and the fuel reservoir and/or storage tank 30 (e.g., by controlling a valve in conduit 12 to control flow through the conduit 12 and/or to the storage tank 30). Therefore, the device 100 may further comprise a fuel storage reservoir intermediate between the artificial photosynthesis fuel generator 10 and the power generator 14, the fuel storage reservoir being configured to store the fuel produced by the artificial photosynthesis fuel generator 10 and to provide a buffered supply of the fuel to the power generator 14 to accommodate differences in production and demand.

As shown in FIG. 1, the artificial photosynthesis fuel generator 10 may receive inputs of water and carbon dioxide and/or hydrogen, as well as an input of light energy (e.g., sunlight 18), and produces a chemical fuel. The fuel may be stored temporarily in a fuel reservoir and/or directed via a conduit 12 to the power generator 14. The power generator 14 may convert the fuel into usable power output (electricity or mechanical work), and in the process may generate exhaust containing water and carbon dioxide. The exhaust may be captured and fed via a return conduit 16 back to the artificial photosynthesis fuel generator 10. In this manner, the CO₂ and H₂O may continuously be cycled between the two units, forming a closed-loop for the reactants.

Accordingly, the only ongoing external input required for the production of fuel may be sunlight 18 (or another energy source to drive the photosynthetic reaction), and the useful output may be electrical (and/or mechanical) energy.

Artificial photosynthesis offers a way to produce fuels sustainably. The artificial photosynthesis device 100 may produce liquid fuels at efficiencies in the order of ten times greater than natural photosynthesis (i.e., uncontrolled natural photosynthesis utilising plants), using only sunlight 18, water, and CO₂ as ingredients.

Further, the fuels produced by the system may not contribute net greenhouse gases to the atmosphere when used, as the carbon released by the power generator 14 may be utilised as a feedstock for the system. The device 100 of the present disclosure provides advantages; unlike biofuels from crops, the fuels produced by the system do not compete with food production or require arable land.

Prior systems treat renewable fuel generation (e.g., hydrogen from solar electrolysis) and power generation (e.g. fuel cells or combustion engines) as separate stages, often geographically or temporally separated. This may result in process efficiency losses and/or losses of CO₂ produced from fuel use to the environment.

The present disclosure integrates an on-site artificial photosynthesis module with a power generator 14 in a self-contained cycle that continuously recycles all major inputs and outputs. The present disclosure provides a practical device 100 that links these components so that the carbon dioxide and water outflows from power generation are fed directly back into fuel production, which may create a closed-loop, carbon-neutral cycle.

As described above, the device 100 may provide a closed-loop sustainable power generation system in which a fuel produced by artificial photosynthesis is continuously cycled to generate power with little to no net waste products.

The physical configuration of the artificial photosynthesis energy device 100 can be adapted for different scales: a small portable unit may integrate all components in one enclosure (for example, with solar panels on top, a fuel cartridge, and a fuel cell), whereas a large installation might have separate arrays of solar fuel generators and a centralized power plant unit.

The system may also be integrated with external infrastructure; for example, if excess fuel is produced, it could be exported for other uses, whilst maintaining a closed loop configuration for the mechanism of artificial photosynthesis and fuel generation within the device 100 itself.

Further, external CO₂ could be fed in (from air or industrial sources) to increase fuel production if desired, effectively allowing the system to also act as a carbon capture device.

### Artificial Photosynthesis Fuel Generator 10

The artificial photosynthesis fuel generator 10 may be configured to produce a fuel using input resources such as water and carbon dioxide and an energy input from light (preferably sunlight 18). The power generator 14 may be coupled to receive and utilize the fuel to generate electricity or mechanical power. The utilization of the fuel may produce reaction byproducts including water and/or carbon dioxide.

The recycle loop or subsystem may connect the output of the power generator 14 back to the input of the artificial photosynthesis fuel generator 10 and/or the power generator 14. The recycle loop may comprise a subsystem configured to capture byproduct gases or liquids (e.g. CO₂ and water) from the power generator 14 and supply them as feedstock for the artificial photosynthesis fuel generator 10.

In operation, the artificial photosynthesis fuel generator 10 may utilise solar energy (or another light source) to convert carbon-neutral feedstocks into an energy-rich fuel. The fuel can be, for example, hydrogen gas (by splitting water) or a carbon-based fuel (such as methanol or other hydrocarbon produced by reducing CO₂ with hydrogen).

The artificial photosynthesis fuel generator 10 can be implemented by any suitable artificial photosynthesis technology capable of using light to produce a fuel from basic inputs.

The reactor of the artificial photosynthesis fuel generator 10 may be a photoelectrochemical reactor, comprising: a photoactive electrode and a catalyst for improving the efficiency of conversion of the feed material into the fuel. The reactor of the artificial photosynthesis fuel generator 10 may be a bio-hybrid reactor, comprising: algae and/or bacteria. The artificial photosynthesis fuel generator 10 may comprise a solar concentrator. The solar concentrator may concentrates light energy from a light source. The solar concentrator may direct light towards a light receiver of the artificial photosynthesis fuel generator 10.

The artificial photosynthesis fuel generator 10 may be a photoelectrochemical reactor containing one or more photoactive electrodes (for example, semiconductor photoabsorbers) and appropriate catalysts. In particular, the artificial photosynthesis fuel generator 10 may comprise a photoelectrochemical reactor including one or more light-absorbing semiconductor electrodes and one or more catalysts for facilitating reactions that convert the water and carbon dioxide into the fuel upon exposure to sunlight 18 (or an artificial light source).

For example, a design may use a semiconductor electrode (e.g., silicon, GaAs, and/or a metal-oxide photoanode) to absorb sunlight 18 and generate charge carriers, which may drive the splitting of water into hydrogen and oxygen, or the reduction of carbon dioxide into carbon-based fuels.

Feedstocks such as water (H₂O) and/or carbon dioxide (CO₂) may be fed into the reactor. Water and/or carbon dioxide may be introduced as liquids, gases, or in dissolved form. When sunlight 18 and/or other light-based energy illuminates the reactor, the photocatalytic process may convert the water and/or CO₂ into a fuel and oxygen.

Accordingly, the feed material and/or the at least one byproduct may comprise water. The artificial photosynthesis fuel generator 10 may be configured to produce hydrogen gas from the feed material and/or the at least one byproduct. In particular, the specific fuel produced can vary based on the feedstock used. In some implementations, the primary fuel produced may be hydrogen gas, for example generated by the reaction:

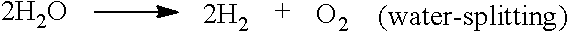

As described in more detail, below, the power generator 14 may comprises a hydrogen fuel cell for converting hydrogen (and oxygen) into energy. In particular, the fuel produced by the artificial photosynthesis fuel generator 10 may be hydrogen gas. The power generator 14 may comprise a hydrogen fuel cell that combines the hydrogen fuel with oxygen to generate electricity and water as said exhaust byproduct.

In other implementations, the artificial photosynthesis fuel generator 10 may produce a hydrocarbon or alcohol fuel by reducing CO₂. For instance, catalysts and reactor conditions can be chosen to produce methanol (CH₃OH) from CO₂ and H₂ via reactions such as:

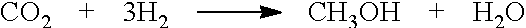

Catalysts for such reactions may include copper-based, precious metal-based, composite-based, alloy-based, and/or metal-based catalysts.

Other reactions using CO₂ may produce fuel products such as methane (CH₄), ethanol, and/or other carbon-based fuels.

Accordingly, the feed material and/or the at least one byproduct may comprise carbon dioxide and hydrogen. The artificial photosynthesis fuel generator 10 may be configured to produce an alcohol and/or a hydrocarbon from the feed material and/or the at least one byproduct.

As described in more detail, below, the power generator 14 may comprise at least one of:
a gas turbine coupled to an electrical generator;
an internal combustion engine coupled to an electrical generator; and
a direct methanol fuel cell.

Therefore, the power generator 14 may be an internal combustion engine and/or a gas turbine coupled to an electrical generator. The engine and/or turbine may be configured to combust the fuel to produce mechanical power. The engine and/or turbine may have an exhaust output containing carbon dioxide and water.

For example, a reaction of CO₂ to methane may be as follows:

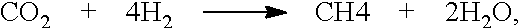

Catalysts for such reactions may include nickel-based, ruthenium-based, composite-based, alloy-based, and/or metal-based catalysts.

It will be appreciated that the fuel type may not be limited to the examples above; any chemical fuel that can be generated from CO₂ or H₂O and later oxidized in a controlled manner may be used.

Fuels that may be produced by the artificial photosynthesis fuel generator 10 include, but are not limited to, synthetic methane, ethane, various alcohols, ammonia (from N₂ and H₂O), or even more complex synthetic hydrocarbons. A nitrogen source may be a nitrogen containing gas, such as air, or a nitrogen gas, or a mix of air and pure nitrogen gas. When the artificial photosynthesis fuel generator 10 is configured to produce ammonia, an iron-based catalyst may be used. Accordingly, the feed material and/or the at least one byproduct may further comprise a nitrogen containing gas or nitrogen gas. The artificial photosynthesis fuel generator 10 may be configured to produce an ammonia from the feed material and/or the at least one byproduct.

Therefore, the fuel produced may comprise a carbon-based fuel selected from the group consisting of: an alcohol, a hydrocarbon, and ammonia. The carbon dioxide from the exhaust of the power generator 14 may, therefore, be derived from oxidation of said carbon-based fuel by the power generator 14 and may be recycled to the artificial photosynthesis fuel generator 10.

The artificial photosynthesis mechanism may be photoelectrochemical as described, or purely photocatalytic (e.g., a slurry of catalyst particles in a reactor), or bio-hybrid (e.g., using engineered algae or bacteria in a bioreactor alongside a solar concentrator). It will be appreciated that the artificial photosynthesis mechanism is a human-controlled system (in comparison to natural photosynthesis in unmanaged ecosystems) that produces a useful fuel.

The power generation mechanism as described in more detail, below, can likewise vary: besides fuel cells and engines, the device 100 may include a thermochemical generator or a hybrid fuel cell/turbine system, etc.

The reaction(s) in the artificial photosynthesis fuel generator 10 may occur in a single step inside a single photoelectrochemical cell. The reaction(s) in the artificial photosynthesis fuel generator 10 may occur in multiple stages (for example, first generating H₂, then reacting H₂ with CO₂ in a secondary catalytic reactor to produce methanol). In other words, it will be appreciated that the artificial photosynthesis fuel generator 10 may be a staged unit comprising more than one stage of processing units. For example, a first stage may split water to produce hydrogen gas, and a second stage may reduce CO₂ with H₂ to produce methanol and water. The water may be separated from the methanol to be fed directly back to the first stage to produce H₂ for the second stage. Further, the oxygen produced by the first stage may be fed to the power generator 14, for example to assist combustion. The methanol may then be fed to the power generator 14.

The design of the artificial photosynthesis fuel generator 10 may incorporate processing features suitable for the reaction being performed. For example, such processing features may include, but may not be limited to: membranes to separate oxygen gas (O₂) out of the reaction chamber (e.g., oxygen and hydrogen separation membranes, such as inorganic, polymeric, composite, microporous membranes); catalysts (such as metal nanoparticles, metal oxides, or molecular catalysts) optimized for the desired fuel production reaction; and/or light concentrating optics or solar tracking to maximize photon input.

Oxygen gas is a typical byproduct of artificial photosynthesis. In particular, in the artificial photosynthesis fuel generator 10, oxygen may be evolved, particularly if water is oxidized to provide electrons for fuel formation (for example, water oxidation produces O₂ when generating H₂).

Accordingly, the artificial photosynthesis fuel generator 10 may produce oxygen gas as a byproduct during fuel production. The device 100 may further comprise a conduit or mechanism to supply at least a portion of the produced oxygen gas to the power generator 14 for use as the oxidant in the fuel reaction, thereby reducing or eliminating a need for external oxidant input.

The oxygen produced by the artificial photosynthesis fuel generator 10 may be handled in two ways:
(a) oxygen may be vented or released to the environment. Releasing oxygen is not harmful and does not accumulate to cause pollution (releasing O₂ may be beneficial); or
(b) oxygen may be captured and reused. For example, the system can store the O₂ and supply it to the power generator 14 to support combustion of a fuel.

It will be appreciated that a portion of the oxygen produced by the artificial photosynthesis fuel generator 10 may be vented and/or recycled.

Using the O₂ internally is advantageous in a combustion-based generator, as it avoids drawing in outside air and further closes the system (preventing introduction of nitrogen or other external gases).

In either case, the oxygen output does not pose an environmental concern and the core carbon and hydrogen elements remain in the closed loop.

The artificial photosynthesis fuel generator 10 may be constructed with durable materials suitable for continuous operation under solar illumination. It may employ, for example, corrosion-resistant coatings on photoelectrodes, and cooling/heating systems to maintain optimal reaction temperature.

Bio-inspired designs such as catalyst-bearing membranes or multi-layer structures may be used, such as a multi-layer artificial leaf device with separate regions for light absorption, catalysis, and product collection.

The device 100 can be constructed using modular panels or reactors. For example, multiple artificial photosynthesis panels (each roughly notebook-sized or larger) may be tiled or scaled up to produce commercial quantities of fuel, which in turn may support large-scale power generation.

The efficiency of the artificial photosynthesis fuel generator 10 in converting sunlight 18 to fuel may be higher that natural photosynthesis efficiency. In particular, the efficiency of the artificial photosynthesis fuel generator 10 in converting sunlight 18 to fuel may be in the order of 10% or more of incident solar energy converted to chemical energy. This efficient fuel generation may enable a relatively compact device 100 to produce sufficient fuel for continuous power generation.

### Power Generator 14

The fuel produced by the artificial photosynthesis fuel generator 10 is then fed into the power generator 14 which may be, for instance, a fuel cell or a combustion engine as described in more detail herein.

The power generator 14 may converts the chemical energy of the fuel into electrical power (and/or mechanical work), emitting water (for hydrogen fuel) or water and CO₂ (for carbon-based fuels) as exhaust.

The recycler 16 may capture these exhaust products—particularly CO₂ and water—and returns them to the artificial photosynthesis fuel generator 10 as the raw materials to make more fuel.

In this way, the carbon loop may be closed: CO₂ released from the fuel's use is not vented to the atmosphere but is instead re-used to synthesize new fuel. Accordingly, the only net input to the system may be renewable energy (sunlight 18), and the only net output may be useful power. Oxygen may be produced as a byproduct of the photochemical reactions; this oxygen can be released safely or optionally routed to the power generator 14 for combustion, thereby also closing the oxygen loop.

The system may have a particularly high energy efficiency and commercial viability.

As described above, the artificial photosynthesis fuel generator 10 can employ high-efficiency photoabsorbers and durable catalysts to achieve fuel production rates far exceeding those of natural photosynthesis.

As described herein, the fuel produced by the artificial photosynthesis fuel generator 10 may be storable.

Accordingly, the device 100 may further comprise an auxiliary energy storage system for collecting and storing solar energy. Consequently, prior to use in the power generator 14, the system may effectively bank solar energy in chemical form during peak sunlight 18 and later use the fuel to generate power on demand (e.g. at night or during cloudy conditions). This intrinsic energy storage via fuel may ensure a continuous power output, addressing the intermittency of solar energy. Further, the device 100 may further include an auxiliary light source for providing solar energy to the artificial photosynthesis fuel generator 10 (and/or the device 100) during low light conditions.

As described herein, the power generator 14 can be adapted to the chosen fuel type. For example, for hydrogen fuel, a proton-exchange membrane fuel cell or similar fuel cell stack may be used. For liquid fuels like methanol, a direct methanol fuel cell or an internal combustion engine/turbine coupled to an electric generator may be used. Therefore, the power generator 14 may be a fuel cell stack configured to electrochemically convert the fuel to electricity.

As will be appreciated, if methanol is used as a fuel, the overall reaction mechanism of the conversion of methanol to energy (using a direct methanol fuel cell or via combustion) may be as follows:

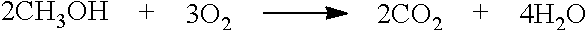

If hydrogen is used as a fuel, the overall reaction mechanism of the conversion of hydrogen to energy (using a proton-exchange membrane fuel cell or similar, or via combustion) may be represented as follows:

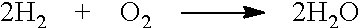

The recycler 16 may include heat exchangers, chemical absorbers, or membrane separators as described in more detail herein to efficiently capture and route CO₂ and water from the exhaust stream back into the photosynthesis reactor. Therefore, the device 100 may include a gas capturer fluidly connected to the power generator 14 and to the recycler 16. The gas capturer may be configured to capture at least a portion of at least one of carbon dioxide and water from the power generator 14 and to feed the at least one of carbon dioxide and water to the artificial photosynthesis fuel generator 10.

Accordingly, the recycler 16 may comprise a carbon dioxide capture unit configured to extract or separate carbon dioxide from the exhaust byproducts of the power generator 14 before supplying the carbon dioxide to the artificial photosynthesis fuel generator 10.

The power generator 14 is configured to accept the fuel produced by the artificial photosynthesis fuel generator 10 and convert it into electricity (and possibly useful heat or mechanical work). The specific nature of the power generator 14 depends on the fuel type. If the fuel is hydrogen gas, the power generator 14 may be a fuel cell—for example, a Proton Exchange Membrane Fuel Cell (PEMFC) stack that electrochemically combines hydrogen from the artificial photosynthesis fuel generator 10 with oxygen (from air or from the O₂ output of the artificial photosynthesis fuel generator 10) to produce electricity, with water as the only chemical byproduct. In another aspect, if the fuel is a liquid hydrocarbon or alcohol (e.g., methanol), the power generator 14 may be a direct methanol fuel cell (DMFC), which oxidizes methanol to produce CO₂, water, and electricity. Yet another aspect may use a combustion-based generator: for instance, a small internal combustion engine or gas turbine can be used to burn a hydrocarbon fuel (methanol, methane, synthetic gasoline, etc.) to drive a generator or motor. Combustion will yield exhaust gases including CO₂ and water vapor. The power generator 14 can also be a hybrid system; for example, a combustion engine's waste heat could be recovered to drive a steam turbine or used in a thermoelectric generator for improved efficiency (cogeneration).

Regardless of the type, the power generator 14 is designed to produce useful power output to supply an external load (which could be an electrical grid, an industrial facility, an electric vehicle drivetrain, etc.).

The capacity of power generator 14 may be scaled as needed. For example, multiple fuel cell stacks or engines can operate in parallel for larger power output.

The power generator 14 may be integrated with the artificial photosynthesis fuel generator's 10 operation. For example, the energy production of the power generator 14 may be modulated based on fuel availability and power demand. For instance, when solar conditions are excellent and fuel production is high, the system might run the generator at full capacity or store excess fuel; when solar input is low, the system can draw on stored fuel to maintain power output.

The exhaust of the power generator 14 may be managed rather than freely emitted. For example, in a hydrogen fuel cell scenario, the exhaust may be primarily water (typically produced as water vapor or liquid water). In a hydrocarbon combustion or fuel-cell scenario, the exhaust will contain carbon dioxide and water, and possibly minor amounts of other benign constituents (e.g., oxygen or nitrogen if air is used).

The invention includes means to capture these exhaust products effectively. For example, the exhaust from a combustion engine 14 can be routed through a condenser to liquefy and collect water, and through a CO₂ capture module to separate the carbon dioxide. CO₂ capture can be accomplished by chemical absorbers (such as amine-based scrubbers that bind CO₂), by membranes that selectively permeate CO₂, and/or by pressure/temperature swing adsorption units, among other techniques. The captured CO₂ and the collected water may then be directed back into the artificial photosynthesis fuel generator 10.

### Recycler 16

The recycler 16 is responsible for transporting the byproducts from the power generator 14 back to the fuel production unit (the artificial photosynthesis fuel generator 10). In some aspects, the recycler 16 may transport the byproducts from the power generator 14 back to the power generator 14 (e.g., directing byproducts directly back to the power generator 14). The recycler 16 may be considered as a recycling subsystem.

The recycler 16 may include pipes, valves, storage tanks 30, and processing components as needed. For instance, the system can include a water reservoir and pump to send water from the power generator's 14 exhaust (or condensed from fuel cell output) into the artificial photosynthesis reactor 10. Likewise, a CO₂ storage tank 30 or direct feed line holds the CO₂ extracted from the generator exhaust and feeds it (potentially under pressure) into the artificial photosynthesis fuel generator 10. In an integrated design, the artificial photosynthesis fuel generator 10 might operate at a certain pressure to favour fuel synthesis (for example, CO₂ reduction often benefits from higher pressure CO₂). The recycler 16 can thus compress the recovered CO₂ as needed. Importantly, virtually all CO₂ that is produced by fuel usage may be captured and reused, so the system does not emit CO₂ to the atmosphere during normal operation. This may ensure the carbon loop is closed and the overall process is carbon-neutral. Any minor losses (e.g., trace leakage of CO₂ or water) can be offset by intakes of make-up CO₂ or water from the environment if necessary, but the design goal is to minimize such losses with proper sealing and recycling.

### Control System

The device 100 may include an electronic control system, such as a controller as described herein (e.g., a computing device or system having a memory, a microcontroller or a process logic controller (PLC)). The control system and/or the controller may comprise a SCADA (Supervisory Control and Data Acquisition) system for controlling the device 100 (and/or system) as described herein. The electronic control system may include sensors and actuators to monitor and optimize performance of the artificial photosynthesis energy device 100.

Accordingly, the device 100 may further comprise a control system (or controller) with one or more sensors and processors configured to monitor operational parameters of the artificial photosynthesis fuel generator 10 and the power generator 14 and to adjust the operation of the system so as to balance the rate of fuel production with the rate of power generation (e.g., the power generated and/or the power output level by the power generator 14), thereby maintaining stable closed-loop operation under varying environmental conditions and power load demands.

Sensors may monitor parameters such as light intensity of the light contacting the artificial photosynthesis fuel generator 10, the rate of fuel production of the artificial photosynthesis fuel generator 10, fuel levels of the storage tank(s) 30 and/or reservoir connected to the power generator 14, pressure and temperature in the reactors (e.g., the power generator 14 and/or the artificial photosynthesis fuel generator 10), the power output level of the power generator 14, and the composition of the exhaust gases released from the power generator 14. Other sensors may include flow sensors for measuring the flowrate of feed materials entering the artificial photosynthesis fuel generator 10, flowrate of fuel produced and flowing to the storage tank(s) 30 and/or the power generator 14, and/or the flowrate of the at least one byproduct leaving the power generator 14.

Accordingly, the device 100 may further comprise a controller. The controller may comprise at least one sensor. The at least one sensor may be configured to perform measurements of at least one parameter selected from the list of:
rate of fuel production of the artificial photosynthesis fuel generator 10;
pressure in the power generator 14;
temperature in the power generator 14;
pressure in the artificial photosynthesis fuel generator 10;
temperature in the artificial photosynthesis fuel generator 10;
power output level of the power generator 14;
composition of the at least one byproduct produced by the power generator 14;
flowrate of feed material into the artificial photosynthesis fuel generator 10; and
flowrate of the at least one byproduct produced by the power generator 14.

It will be appreciated that such sensors may be located at parts of the artificial photosynthesis energy device 100 suitable for measuring such parameters. In particular, pressure and temperature sensors in the reactors may be located within the power generator 14 and/or the artificial photosynthesis fuel generator 10. The flowrate sensor(s) for feed material and/or byproduct flow to the artificial photosynthesis fuel generator 10 may be located proximal to an inlet 9 of the artificial photosynthesis fuel generator 10. The flowrate sensor(s) for measuring flowrate of fuel produced may be located proximal to an outlet port 11 of the artificial photosynthesis fuel generator 10. The flowrate sensor(s) for measuring flowrate of fuel to the power generator 14 may be located proximal to an inlet 13 of the power generator 14. The fuel storage tank(s) 30 and/or reservoir may include level sensors for measuring the level and/or volume of fuel within the tank(s) 30 and/or reservoir. The flowrate sensor(s) for measuring flowrate of the exhaust from the power generator 14 may be located proximal an outlet (e.g., a gas outlet and/or a liquid outlet) of the power generator 14.

In configurations where the light energy is provided by natural sunlight 18, the artificial photosynthesis fuel generator 10 may include solar collection means (e.g., a solar collector) for capturing or concentrating sunlight 18 onto active surfaces of the artificial photosynthesis fuel generator 10 (or another part of the device 100 configured to receive light energy). The system may include an auxiliary light source or solar simulator to drive fuel production during periods of insufficient natural sunlight 18.

Using the data measured by the sensor(s), the control system may adjust variables. For example, the control system may modulate the operating current of a fuel cell, the fuel feed rate to an engine, or the orientation of a solar collector for the artificial photosynthesis fuel generator 10. The control system may also control flow control system such as pumps and/or compressors for providing feed materials to the artificial photosynthesis fuel generator 10, fuel to the storage tank(s) 30 and/or the power generator 14, and recycling exhaust gases and/or outlet materials from the power generator 14 back to the artificial photosynthesis fuel generator 10.

The device 100 may further comprise a valve located in a flowpath between the artificial photosynthesis fuel generator 10 and the power generator 14. The controller may be configured to control the valve to modulate a flowrate of the fuel produced from the artificial photosynthesis fuel generator 10 to the power generator 14.

The device 100 may further comprise a valve located in a flowpath between the power generator 14 and the recycler 16. The controller may be configured to control the valve to modulate a flowrate of the byproduct produced from the power generator 14 to the recycler 16.

The device 100 may further comprise a valve located in a flowpath between the recycler 16 and the artificial photosynthesis fuel generator 10. The controller may be configured to control the valve to modulate a flowrate of the byproduct to the artificial photosynthesis fuel generator 10.

The control system, e.g., the controller as described herein, may also control auxiliary systems like pumps for cooling water or fans for heat management. Accordingly, the artificial photosynthesis fuel generator 10 may comprise at least one of a cooling system and a heating system. The power generator 14 may comprise at least one of a cooling system and a heating system. The control system, such as a controller, may control such cooling and heating systems.

Therefore, the device 100 may include cooling water pumps which control cooling water flow to at least one of the artificial photosynthesis fuel generator 10 and the power generator 14. The controller may be configured to control the cooling water pump to control the temperature of the at least one of the artificial photosynthesis fuel generator 10 and the power generator 14.

The control system may balance fuel production with power generation. For example, if the power demand is lower than the fuel production rate (during a sunny period, for instance), the system can direct fuel production flow to store excess fuel in a reservoir(s) 12 and/or in an external storage tank(s) 30 to be used later.

Conversely, if power demand is high but sunlight 18 is low (e.g., at night), the control system can draw from stored fuel in the storage tank(s) 30 and/or reservoir(s) 12 to keep the generator running, effectively using the system's prior fuel reserves.

Therefore, the control system may enable a balance for ensuring continuous operation and prevents build-up of excess reactants or products.

Accordingly, the controller may be configured to monitor the one or more parameters and control the artificial photosynthesis fuel generator 10, the power generator 14, and/or the valve or valves to balance the rate of fuel production from the artificial photosynthesis fuel generator 10 and power output level (e.g., power production) by the power generator 14.

In addition, safety controls may be provided: hydrogen detectors, pressure relief valves, oxygen sensors, etc., which may ensure safe handling of gases and automatic shutdown.

The control system may include a controller, such as a processor, for controlling the system. The control system may be automated. The control system may provide an output to a display, for example to an operator. The control system may be wirelessly connected to the system. The control system may be connected to the system using wires. The control system may be connected to the system both wirelessly and wired.

Additionally or alternatively, the control system may be automated, but may require an input, for example, when specific processing parameters are exceeded, for example, excess temperature of the power generator 14, excess fuel levels in the storage tank(s) 30, etc. Such parameters being exceeded may prompt an operator to provide an input, e.g., to shut down the system. Additionally or alternatively, the control system may shut down the system if parameters are exceeded. The control system may operate on a two-tier system, for example if parameter(s) (e.g., temperature, flow rate, fuel levels) are too high or too low, i.e., above or below a threshold value, respectively (representing HIGH and LOW values, respectively), the control system may prompt an operator to check the system conditions and/or recommend a course of action for the operator to take. If the parameter(s) continue to exceed such levels, e.g., if the values increase or decrease past a second (higher, or lower, respectively) threshold value (representing HIGH-HIGH and LOW-LOW values, respectively), the control system may further prompt an operator to check the system conditions and/or recommend a course of action for the operator to take, and/or shut down the system autonomously.

There is also provided an artificial photosynthesis energy system, including: an artificial photosynthesis fuel generator 10, incorporating: an inlet 9 for receiving at least one of a feed material and at least one byproduct, a reactor which converts the feed material and light energy to a fuel, and an outlet 11 which feeds the fuel to a power generator 14 which generates electricity and produces the at least one byproduct from the fuel; the power generator 14, incorporating: an inlet 13 fluidly connected to the outlet 11 of the artificial photosynthesis fuel generator 10, and an outlet; and a recycler 16 which directs at least a portion of the at least one byproduct from the outlet of the power generator 14 to the inlet 9 of the artificial photosynthesis fuel generator 10.

The system may include any of, any combination of, or all of the features and advantages of the artificial photosynthesis energy device 100 as described herein. It will be appreciated that the system, whilst forming a closed loop configuration as described herein in relation to the device 100, may not require the artificial fuel generator 10, the power generator 14, and the recycler 16 to be located within the same unit (e.g., not within the same device). The system may comprise artificial fuel generator 10, the power generator 14, and the recycler 16 located geographically distant from one-another, but may still maintain the closed loop configuration as described herein.

The device 100 as described herein may comprise a combination of features as described herein. For example, there is provided: an artificial photosynthesis energy device 100, the device 100 comprising: an artificial photosynthesis fuel generator 10, incorporating: an inlet 9 for receiving at least one of a feed material and at least one byproduct, which incorporates a solar concentrator which concentrates light energy from a light source and uses the concentrated light energy to convert the at least one of the feed material and the at least one byproduct to a fuel, and an outlet 11 which feeds the fuel to a power generator 14 which generates electricity and produces the at least one byproduct from the fuel; the power generator 14, incorporating: an inlet 13 fluidly connected to the outlet 11 of the artificial photosynthesis fuel generator 10, and an outlet 15, wherein the device further comprises a recycler 16 which directs at least a portion of the at least one byproduct from the outlet of the power generator 14 to the inlet 9 of the artificial photosynthesis fuel generator 10, wherein the reactor of the artificial photosynthesis fuel generator 10 is one of: a photoelectrochemical reactor, incorporating: a photoactive electrode and a catalyst for improving the efficiency of conversion of the feed material into the fuel, or a bio-hybrid reactor, incorporating: algae and/or bacteria; wherein at least one of: the feed material and/or the at least one byproduct comprises water, the artificial photosynthesis fuel generator 10 is configured to produce hydrogen gas from the feed material and/or the at least one byproduct, and the power generator 14 comprises a hydrogen fuel cell; the feed material and/or the at least one byproduct comprises water and further comprises a nitrogen containing gas or nitrogen gas, the artificial photosynthesis fuel generator 10 is configured to produce an ammonia from the feed material and/or the at least one byproduct; or the feed material and/or the at least one byproduct comprises carbon dioxide and hydrogen, the artificial photosynthesis fuel generator 10 is configured to produce an alcohol and/or a hydrocarbon from the feed material and/or the at least one byproduct, and the artificial photosynthesis fuel generator 10 comprises at least one of: a gas turbine coupled to an electrical generator; an internal combustion engine coupled to an electrical generator; and a direct methanol fuel cell; wherein the device 100 further comprises a controller incorporating at least one sensor which measures at least one parameter selected from a group of parameters including: rate of fuel production of the artificial photosynthesis fuel generator 10; pressure in the power generator 14; temperature in the power generator 14; pressure in the artificial photosynthesis fuel generator 10; temperature in the artificial photosynthesis fuel generator 10; power output level of the power generator 14; composition of the at least one byproduct produced by the power generator 14; flowrate of feed material into the artificial photosynthesis fuel generator 10; and flowrate of the at least one byproduct produced by the power generator 14: wherein the device 100 comprises one or more of: a valve located in a flowpath between the artificial photosynthesis fuel generator 10 and the power generator 14 the controller controlling the valve to modulate a flowrate of the fuel produced from the artificial photosynthesis fuel generator 10 to the power generator 14; a valve located in a flowpath between the power generator 14 and the recycler 16, the controller controls the valve to modulate a flowrate of the byproduct produced from power generator 14 to the recycler 16; and a valve located in a flowpath between the recycler 16 and the artificial photosynthesis fuel generator 10 and wherein the controller controls the valve to modulate a flowrate of the byproduct to the artificial photosynthesis fuel generator 10, and wherein the controller monitors the one or more parameters and controls the artificial photosynthesis fuel generator 10, the power generator 14, and the valve or valves to balance the rate of fuel production from the artificial photosynthesis fuel generator 10 and power output level of the power generator 14.

### Operation of the Artificial Photosynthesis Energy Device 100

There is also provided a method of generating power using artificial photosynthesis, comprising flowing at least one of: a feed material, and at least one byproduct, through an inlet 9 of an artificial photosynthesis fuel generator 10. The artificial photosynthesis fuel generator 10 may comprise a catalyst. The method comprises converting the at least one of: the feed material, and the at least one byproduct, to a fuel using light energy (e.g., from sunlight 18). The feed material and the at least one byproduct may comprise hydrogen. The feed material and the at least one byproduct may additionally or alternatively comprise carbon dioxide, water, a nitrogen gas, and/or a nitrogen containing gas. The method comprises flowing the fuel through an outlet 11 of the artificial photosynthesis fuel generator 10 through an inlet 13 of a power generator 14; generating electricity by using a fuel cell or by combustion and generating a byproduct from the reaction of the fuel at the fuel cell or via combustion. The method comprises flowing at least a portion of the byproduct through a recycler 16 through the inlet 9 of the artificial photosynthesis fuel generator 10. As described herein, the at least one of the feed material and the at least one byproduct of the method may comprise at least one of: hydrogen, carbon dioxide, and water. It will be appreciated that the feed material and/or the at least one byproduct may include a nitrogen gas or a nitrogen containing gas (or a combination of nitrogen gas and a nitrogen containing gas, such as air, to enrich the nitrogen containing gas with nitrogen). As described herein, the artificial photosynthesis fuel generator 10 comprises at least one of: a catalyst, a photocatalyst, a biohybrid reactor including algae and/or bacteria, and a solar concentrator.

The method may include any of, any combination of, or all of the features and processing considerations as described herein in relation to the device 100.

In an illustrative operation scenario, the device 100 is installed in a location with ample sunlight 18.

In daylight, the artificial photosynthesis fuel generator 10 actively produces hydrogen fuel using solar energy and water (with O₂ as a byproduct). The hydrogen may be accumulated and fed into a fuel cell in the power generator 14, generating electricity to power a load (e.g., a household or equipment). The fuel cell may combine hydrogen with oxygen (sourced from the air or from the O₂ produced by the artificial photosynthesis fuel generator 10) to produce water and electricity. The water output from the fuel cell may be captured, filtered if necessary, and pumped back into the water supply of the artificial photosynthesis reactor 10. As evening approaches and sunlight 18 wanes, the control system may ramp down the photochemical reactor and rely on stored hydrogen to continue running the fuel cell, thereby providing electricity at night.

Similarly, in an alternate configuration using a carbon-based fuel, during the day the system may use solar energy to convert CO₂ and water into e.g., methanol. The methanol may be stored in a small tank 30. When power is needed, the methanol may be fed into a combustion engine generator (e.g., the power generator 14 as described herein). The engine may burn the methanol with oxygen (from air or a stored supply), producing mechanical energy converted to electricity, and exhaust consisting of CO₂ and water vapor. This exhaust may be cooled; the water may be condensed and returned, and the CO₂ may be separated and fed back to the photoreactor (e.g., the artificial photosynthesis fuel generator 12). Through another cycle, that CO₂ may again be turned into fuel. In this way, day after day, the cycle continues without net consumption of carbon or water (aside from minor losses or system maintenance). Accordingly, the system may create a renewable energy cycle fuelled by sunlight 18.

The method may generate power in a sustainable, closed-loop manner. The method may include: producing a fuel by exposing a mixture of water and carbon dioxide to light in the presence of photocatalysts (artificial photosynthesis); storing or directly transferring the produced fuel to a generator; converting the fuel to produce useful energy (electricity/mechanical) in the generator while forming exhaust comprising water and carbon dioxide; capturing the exhaust components and recycling them back to the fuel production step; and repeating this cycle continuously. The method may further include controlling the rate of fuel production and fuel usage to maintain an energy balance, and using any surplus fuel for storage or peak power demands.

Accordingly, the method may generate power in a closed-loop sustainable manner. In particular, the method may include: a) producing a fuel by artificial photosynthesis, by exposing a reaction mixture comprising water and carbon dioxide to light in the presence of one or more photocatalysts or photoactive electrodes, thereby synthesizing an energy-rich fuel and oxygen gas. The method may include b) generating power by utilizing the fuel, by feeding the fuel into a power conversion device, e.g., the power generator 14, and reacting the fuel to convert its chemical energy into useful power output, wherein said reacting of the fuel produces exhaust containing water and, if the fuel is carbon-based, carbon dioxide. The method may include c) capturing the exhaust (e.g., at least one byproduct as described herein) by collecting at least the water and carbon dioxide from the power conversion device's exhaust stream. The method may include iv) recycling the captured water and carbon dioxide back into the artificial photosynthesis step as reactants for producing new fuel. The water and carbon dioxide may form a closed chemical loop, such that the only substantial energy input to the method may be the light exposure in the fuel producing step.

As described herein, the fuel produced may be hydrogen. The power conversion device (e.g., the power generator 14) may be a fuel cell. The step of generating power may comprise electrochemically reacting the hydrogen with oxygen to produce electricity and water. At least the water may be captured and recycled to the producing step.

As described herein, the fuel produced may be a carbon-containing fuel. The power conversion device, e.g., the power generator 14, may comprise a combustion engine and/or turbine. The step of generating power may comprise oxidizing the carbon-containing fuel to drive the engine and/or turbine and produce carbon dioxide and water as exhaust. The method may further comprise the step of separating and recovering the carbon dioxide from the exhaust for the recycling step so that the carbon dioxide is reused in producing new fuel instead of being released to the atmosphere.

The method may include monitoring and/or controlling the at least one parameter as described herein to balance fuel generation by the artificial photosynthesis fuel generator 10 and power output from the power generator 14.

The disclosed systems and devices 100 may provide carbon-neutral power generation, as the CO₂ released in fuel use may be reclaimed rather than emitted. The device 100 (and system) mimics a regenerative natural cycle but with engineered components optimized for efficiency and output. By integrating fuel generation and power generation on-site, energy losses from fuel transportation or distribution are minimized and the process can be tightly controlled for optimal performance. The system may use solar energy as its primary input, making it renewable and sustainable.

The device 100 as described herein may operate independently as an off-grid power source or be scaled for utility power plants. Because the fuel is produced internally, the device 100 may offer security of fuel supply and price stability. The closed-loop design also means the system may be deployed in sensitive or enclosed environments (for example, in space habitats or remote stations) where emissions must be strictly managed and resources recycled.

In some examples, the device 100 is a self-contained device for providing electricity to power devices at a remote location where there is limited or no mains electricity supply.

For example, in off-grid locations such as in the countryside, desert or mountains.

In some examples, the device 100 is a self-contained device for providing electricity for agricultural use, for example to pump water for irrigation at a remote location.

In some examples, the device 100 is a self-contained device for providing electricity on a ship or boat.

In some examples, the device 100 is a self-contained device for use in disaster relief and to provide emergency power. For example, to provide power during natural disasters, for lighting, emergency shelters, field hospitals, and communication systems when the mains electricity supply is disrupted.

Accordingly, the artificial photosynthesis energy device 100 as described herein may provide a highly efficient, commercially viable clean energy solution that leverages artificial photosynthesis and provides continuous power without fossil fuels or greenhouse emissions.

The closed-loop system of the artificial photosynthesis energy device 100 as described herein may benefit from internal synergies. For example, waste heat from the power generator 14 (especially if it's a combustion engine or a solid oxide fuel cell which runs at high temperature) may be utilized to maintain the operating temperature of the artificial photosynthesis reactor or to preheat water/CO₂ feed, thus improving overall efficiency.

Likewise, oxygen produced in the photochemical unit may be fed to the power generator 14 and used to improve combustion efficiency, when the power generator 14 is configured to combust fuel. In particular, pure O₂ combustion may yield higher flame temperatures and no nitrogen dilution. Accordingly, by insulating and managing thermal and material flows, the system can achieve a high round-trip efficiency from sunlight 18 to electricity. The elimination of greenhouse gas emissions also may increase environmental efficiency; the system may avoid the external costs of pollution and can help reduce overall carbon footprint of energy usage.

Accordingly, the disclosed artificial photosynthesis energy device 100 may provide an integration of artificial fuel synthesis and power generation modules to realize a self-contained, renewable energy cycle.

Examples or embodiments of the subject matter and the functional operations described herein can be implemented in digital electronic circuitry, or in computer software, firmware, or hardware, including the structures disclosed in this specification and their structural equivalents, or in combinations of one or more of them.

Some examples or embodiments are implemented using one or more modules of computer program instructions encoded on a computer-readable medium for execution by, or to control the operation of, a data processing apparatus. The computer-readable medium can be a manufactured product, such as hard drive in a computer system or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The terms “computing device” and “data processing apparatus” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Devices suitable for storing computer program instructions and data include all forms of non-volatile memory, media and memory devices.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. An artificial photosynthesis energy device, the device comprising:
an artificial photosynthesis fuel generator, incorporating:
an inlet for receiving at least one of a feed material and at least one byproduct,
a reactor which incorporates a solar concentrator which concentrates light energy from a light source and uses the concentrated light energy to convert the at least one of the feed material and the at least one byproduct to a fuel, and
an outlet which feeds the fuel to a power generator which generates electricity and produces the at least one byproduct from the fuel;
the power generator, incorporating:
an inlet fluidly connected to the outlet of the artificial photosynthesis fuel generator, and
an outlet, wherein the device further comprises:
a recycler which directs at least a portion of the at least one byproduct from the outlet of the power generator to the inlet of the artificial photosynthesis fuel generator,
wherein the reactor of the artificial photosynthesis fuel generator is a photoelectrochemical reactor incorporating a photoactive electrode; and a catalyst for improving the efficiency of conversion of the feed material into the fuel;
wherein at least one of the feed material and the at least one byproduct comprises water, the artificial photosynthesis fuel generator is configured to produce hydrogen gas from at least one of the feed material and the at least one byproduct, and the power generator comprises a hydrogen fuel cell;
wherein the device further comprises:
a controller incorporating at least one sensor which measures at least one parameter selected from a group of parameters including:
rate of fuel production of the artificial photosynthesis fuel generator;
pressure in the power generator;
temperature in the power generator;
pressure in the artificial photosynthesis fuel generator;
temperature in the artificial photosynthesis fuel generator;
power output level of the power generator;
composition of the at least one byproduct produced by the power generator;
flowrate of feed material into the artificial photosynthesis fuel generator; and
flowrate of the at least one byproduct produced by the power generator,
wherein the device comprises at least one of:
a valve located in a flowpath between the artificial photosynthesis fuel generator and the power generator, the controller controlling the valve to modulate a flowrate of the fuel produced from the artificial photosynthesis fuel generator to the power generator;
a valve located in a flowpath between the power generator and the recycler, the controller controlling the valve to modulate a flowrate of the byproduct produced from the artificial photosynthesis fuel generator to the recycler; and
a valve located in a flowpath between the recycler and the artificial photosynthesis fuel generator, the controller controlling the valve to modulate a flowrate of the byproduct to the artificial photosynthesis fuel generator, and
wherein the controller monitors each parameter and controls the artificial photosynthesis fuel generator, the power generator, and each valve to balance the rate of fuel production from the artificial photosynthesis fuel generator and the power output level of the power generator.

2. An artificial photosynthesis energy device, the device comprising:
an artificial photosynthesis fuel generator, incorporating:
an inlet for receiving at least one of a feed material and at least one byproduct,
a reactor which uses light energy from a light source to convert the at least one of the feed material and the at least one byproduct to a fuel, and
an outlet which feeds the fuel to a power generator which generates electricity and produces the at least one byproduct from the fuel;
the power generator, incorporating:
an inlet fluidly connected to the outlet of the artificial photosynthesis fuel generator, and
an outlet, wherein the device further comprises:
a recycler which directs at least a portion of the at least one byproduct from the outlet of the power generator to the inlet of the artificial photosynthesis fuel generator.

3. The device according to claim 2, wherein the reactor of the artificial photosynthesis fuel generator is a photoelectrochemical reactor, comprising: a photoactive electrode and a catalyst for improving the efficiency of conversion of the feed material into the fuel.

4. The device according to claim 2, wherein the reactor of the artificial photosynthesis fuel generator is a bio-hybrid reactor, comprising at least one of an algae and a bacteria.

5. The device according to claim 2, wherein the artificial photosynthesis fuel generator comprises a solar concentrator which concentrates the light energy from the light source.

6. The device according to claim 2, wherein at least one of the feed material and the at least one byproduct comprises water.

7. The device according to claim 6, wherein the artificial photosynthesis fuel generator is configured to produce hydrogen gas from at least one of the feed material and the at least one byproduct.

8. The device according to claim 7, wherein the power generator comprises a hydrogen fuel cell.

9. The device according to claim 6, wherein at least one of the feed material and the at least one byproduct further comprises a nitrogen containing gas or nitrogen gas.

10. The device according to claim 9, wherein the artificial photosynthesis fuel generator is configured to produce ammonia from at least one of the feed material and the at least one byproduct.

11. The device according to claim 2, wherein at least one of the feed material and the at least one byproduct comprises carbon dioxide and hydrogen.

12. The device according to claim 11, wherein the artificial photosynthesis fuel generator is configured to produce at least one of an alcohol and a hydrocarbon from at least one of the feed material and the at least one byproduct.

13. The device according to claim 12, wherein the artificial photosynthesis fuel generator comprises at least one of:
a gas turbine coupled to an electrical generator;
an internal combustion engine coupled to an electrical generator; and
a direct methanol fuel cell.

14. The device according to claim 2, further comprising at least one of a fuel reservoir and a storage tank fluidly connected between the artificial photosynthesis fuel generator and power generator, the at least one of the fuel reservoir and storage tank arranged to selectively receive at least a portion of the fuel produced by the artificial photosynthesis fuel generator.

15. The device according to claim 2, further comprising an auxiliary energy storage system for collecting and storing solar energy.

16. The device according to claim 2, further including an auxiliary light source for providing solar energy to the artificial photosynthesis fuel generator.

17. The device according to claim 2, further including a controller, the controller comprising at least one sensor, the at least one sensor configured to perform measurements of one or more parameters selected from a group of parameters including:
rate of fuel production of the artificial photosynthesis fuel generator;
pressure in the power generator;
temperature in the power generator;
pressure in the artificial photosynthesis fuel generator;
temperature in the artificial photosynthesis fuel generator;
power output level of the power generator;
composition of the at least one byproduct produced by the power generator;
flowrate of feed material into the artificial photosynthesis fuel generator; and
flowrate of the at least one byproduct produced by the power generator.

18. The device according to claim 17, further comprising at least one of:
a valve located in a flowpath between the artificial photosynthesis fuel generator and the power generator, the controller being configured to control the valve to modulate a flowrate of the fuel produced from the artificial photosynthesis fuel generator to the power generator;
a valve located in a flowpath between the power generator and the recycler, the controller being configured to control the valve to modulate a flowrate of the byproduct produced from the power generator to the recycler; and
a valve located in a flowpath between the recycler and the artificial photosynthesis fuel generator, the controller being configured to control the valve to modulate a flowrate of the byproduct to the artificial photosynthesis fuel generator.

19. The device of claim 18, wherein the controller is configured to monitor each parameter and control the artificial photosynthesis fuel generator, the power generator, and each valve to balance the rate of fuel production from the artificial photosynthesis fuel generator and the power output level of the power generator.

20. A method of generating power using artificial photosynthesis, comprising:
flowing at least one of:
a feed material, and
at least one byproduct,
through an inlet of an artificial photosynthesis fuel generator, wherein the artificial photosynthesis fuel generator comprises a catalyst;
converting the at least one of:
the feed material, and
the at least one byproduct,
to a fuel using light energy, wherein the feed material and the at least one byproduct comprises hydrogen;
flowing the fuel through an outlet of the artificial photosynthesis fuel generator and through an inlet of a power generator;
generating electricity using a fuel cell and generating a byproduct from the reaction of the fuel at the fuel cell; and
flowing at least a portion of the byproduct through a recycler through the inlet of the artificial photosynthesis fuel generator.
